(19) United States
(12) Patent Application Publication
(10) Pub. No.: US 2008/0131038 A1
(43) Pub. Date: Jun. 5, 2008

(54) BEARING ARRANGEMENT FOR A SHAFT

(75) Inventors: Matthew SENDZIK, Waterloo (CA); Ben BAER, Denfield (CA)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 11/936,340

(22) Filed: Nov. 7, 2007

Related U.S. Application Data
(60) Provisional application No. 60/864,805, filed on Nov. 8, 2006.

(51) Int. Cl. F16C 29/06

(52) U.S. Cl. 384/44

(57) ABSTRACT

A bearing arrangement for a shaft (1) in a sleeve (2) which concentrically surrounds said shaft (1) should preferably be used for a water pump, with the bearing arrangement having two cylindrical roller or needle rings (3) which roll directly on the inner periphery of the sleeve (2) and on the outer periphery of the shaft (1). Arranged between said two cylindrical roller or needle rings (3) is a ball ring which rolls in a running groove (13) on the sleeve (2) and a running groove (14) on the shaft (1). The spherical rolling bodies (12) of said ball ring (11) form, together with the running grooves (13 and 14) of the sleeve (2) and of the shaft (1), a four-point bearing.

### FIELD OF THE INVENTION

The invention relates to a bearing arrangement for a shaft in a sleeve which concentrically surrounds said shaft, in particular bearing arrangement for a driveshaft of a water pump, with the bearing arrangement having at least one first rolling bearing with cylindrical rolling bodies which roll on an outer raceway of the shaft and an inner raceway of the sleeve, and a second rolling bearing with spherical rolling bodies which roll in a first running groove in the shaft and a second running groove in the sleeve.

### BACKGROUND OF THE INVENTION

A bearing arrangement for a shaft of the type stated above is known from documents U.S. Pat. No. 2,040,489 and U.S. Pat. No. 3,424,507. In U.S. Pat. No. 3,424,507, the shaft which is mounted in a sleeve is to be the driveshaft of a water pump, which is embodied as a centrifugal pump, for internal combustion engines. In the embodiment of the bearing which can be gathered from the prior art, in particular FIG. 1 of U.S. Pat. No. 2,040,489 and FIG. 9 of U.S. Pat. No. 3,424,507, it is intended to provide a deep groove ball bearing, adjacent to which at both sides are arranged cylindrical roller bearings. The running grooves in the shaft and in the sleeve should have a radius which is only slightly larger than the ball radius of the rolling bodies. By means of a deep groove ball bearing of such design, it is possible, in addition to radial loads, as specified in the documents, to transmit axial thrust forces from the shaft to the sleeve.

### OBJECT OF THE INVENTION

The present invention is based on the object of designing a bearing arrangement of a shaft opposite a sleeve having a high load-bearing capacity. It is also intended that said high load-bearing capacity can be achieved with relatively small dimensions of the bearing arrangement.

### DESCRIPTION OF THE INVENTION

Said object is achieved according to the invention in that the second rolling bearing is formed as a four-point bearing or as a three-point bearing. A four-point bearing of said type absorbs, in the same way, axial loads in both axial directions, with said four-point bearing acting in the manner of a single-row angular contact ball bearing in each of the two axial directions. Four-point bearings have, on the inner and on the outer running groove, two circular-arc-shaped raceways each whose centers of curvature are offset with respect to one another in such a way that the balls are in contact with the shaft and the sleeve at four points in the event of radial loading, wherein said four-point bearings can absorb small radial loads. The great advantage is however that said four-point bearings, in addition to said low radial loads, can absorb high axial loads in both directions. The proposed combination of a four-point bearing with at least one cylindrical roller bearing is therefore highly suitable for the bearing arrangement for the driveshaft of a water pump.

In the case of the three-point bearing which is proposed alternatively to this, the balls should interact with the running groove in the shaft in the same way as in the previously explained four-point bearing, that is to say the balls will be in contact with the circular-arc-shaped raceway of the shaft at two points each in the event of radial loading. The running groove in the sleeve should, in contrast, have a larger radius than the radius of the balls, so that the balls bear in the running groove in only one point against the sleeve in the event of radial loadings. If, however, an axial loading occurs, then, as is the case in the previously explained four-point bearing, there is contact of the balls in the respective running grooves, at only one point each, with the sleeve and with the shaft. In a further embodiment of the invention, the first rolling bearing should, both in the case of the use of a four-point bearing and also of a three-point bearing, be composed of two cylindrical roller bearings which are arranged at both sides of the four-point bearing or of the three-point bearing. Such a combination of the three rolling bearings is suitable for absorbing high radial loads and high axial loads at high rotational speeds.

It is additionally provided that, when using a four-point bearing or a three-point bearing, the spherical rolling bodies bear against the running grooves with a nominal pressure angle α₀ which should be ≦25° and ≦35°. The nominal pressure angle α₀ can advantageously have a value of 35°.

Finally, it is provided in a further embodiment of the invention that, in the bearing arrangement, both in the case of the design of the second rolling bearing as a four-point or as a three-point bearing, only a single-row cylindrical roller bearing should be arranged in addition to these between the shaft and the sleeve. This results in a particularly compact design of the bearing arrangement.

### BRIEF DESCRIPTION OF THE DRAWINGS

Further features of the invention can be gathered from the following description and from the drawings in which two exemplary embodiments of the bearing arrangement according to the invention are illustrated and explained. In the drawings:

FIG. 1 shows a partial longitudinal section through a sleeve with a bearing arrangement according to the invention, with a second rolling bearing forming, together with the shaft and the sleeve, a four-point bearing, and

FIG. 2 shows a partial longitudinal section through a sleeve with a bearing arrangement arranged therein for a shaft, with a second rolling bearing forming, together with the shaft and the sleeve, a three-point bearing.

### DETAILED DESCRIPTION OF THE DRAWINGS

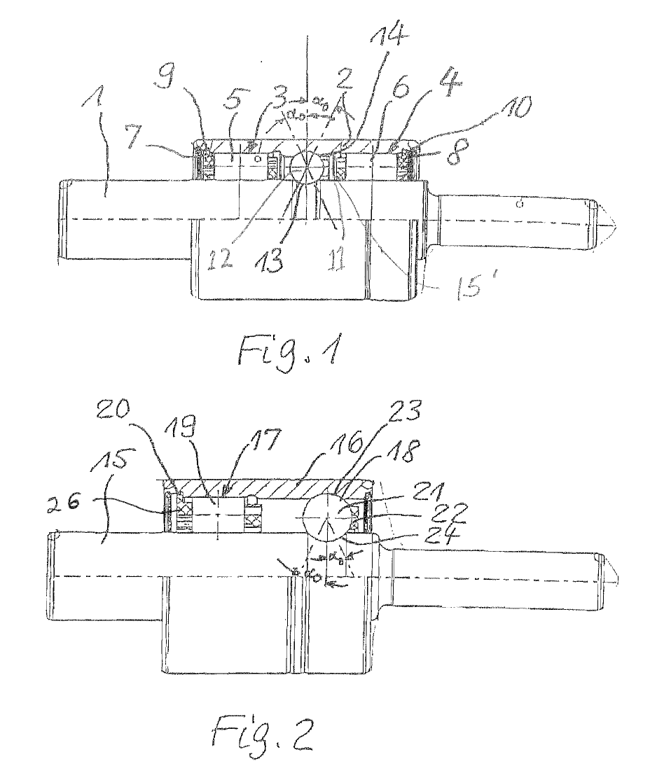

In FIG. 1, 1 denotes a shaft with a stepped outer diameter, with said shaft 1 being mounted, at a section with a larger diameter, in a sleeve 2. The bearing arrangement is composed of two cylindrical roller or needle rings 3 and 4, whose cylindrical rolling bodies 5 and 6 are arranged in cages 7 and 8 which are produced from plastic. Each of said cages is snapped into at least one peripheral groove 9 or 10 which is situated on the inner periphery of the sleeve. Arranged spatially between the two first rolling body sets 3 and 4 is a ball ring 11 which is composed of spherical rolling bodies 12 which roll on the one hand in a running groove 13 on the periphery of the shaft 1 and on the other hand in a running groove 14 on the inner periphery of the sleeve 2. In addition, the spherical rolling bodies 12 are guided in a cage 15′, preferably a snap-action ball cage.

The running grooves 13 and 14 are designed such that the individual spherical rolling bodies, in the event of radial loading of the shaft, bear against the two running grooves 13 and 14 at a total of four points, that is to say at two points each in the running groove 13 and at two points each in the running groove 14. Said contact points are shown in the drawing by dash-dotted lines, with said dash-dotted lines each enclosing a nominal pressure angle α₀ with respect to a vertical, which nominal pressure angle α₀ is 25° in the present case. The corresponding points of contact of the spherical rolling bodies 12 against the running grooves 13 and 14 result as a consequence of said running grooves 13 and 14 being formed with different radii which are joined to one another, so as to generate corresponding shoulders.

In FIG. 2, 15 denotes a shaft which is surrounded by a sleeve 16. Arranged between said shaft 15 and the sleeve 16 is a bearing arrangement which is composed on the one hand of a cylindrical roller or needle ring 17 and on the other hand of a ball ring 18. Both the cylindrical roller or needle ring 17 and the ball ring 18 roll directly on the outer periphery of the shaft and on the inner periphery of the sleeve. Cylindrical rolling bodies 19 of the cylindrical roller or needle ring 17 are arranged in a cage 26 which is produced from plastic and which is itself snapped into a peripheral groove 20 on the inner periphery of the sleeve 16.

The ball ring 18 has spherical rolling bodies 21 which are likewise guided in a cage 22, with said cage 22 preferably being embodied as a snap-action ball cage. Provided in the sleeve 16 is a running groove 23 which has a larger radius than the spherical rolling bodies. A further running groove 24 is formed in the shaft 15, with said running groove 24 bearing against the individual spherical rolling bodies 21 at two points each in the event of radial loading of the shaft 15. In said state of radial loading of the shaft 15, the spherical rolling bodies 21 are on the other hand in contact with the running groove 23 at one point, so that a three-point contact is generated overall. In the case of an axial load on the shaft 15, said three-point bearing (ball ring 18, spherical rolling bodies 21, running grooves 23 and 24) acts in the manner of an angular contact ball bearing, that is to say the spherical rolling bodies bear in the running grooves 23 and 24 diametrically oppositely at in each case one point in the running groove 23 and 24.

### REFERENCE SYMBOLS

1 Shaft
2 Sleeve
3 Cylindrical roller/needle rings
4 Cylindrical roller/needle rings
5 Cylindrical rolling bodies
6 Cylindrical rolling bodies
7 Cage
8 Cage
9 Peripheral groove
10 Peripheral groove
11 Ball ring
12 Spherical rolling bodies
13 Running groove
14 Running groove
15 Shaft
15′ Cage
16 Sleeve
17 Cylindrical roller/needle ring
18 Ball ring
19 Cylindrical rolling bodies
20 Peripheral groove
21 Spherical rolling bodies
22 Cage
23 Running groove
24 Running groove
26 Cage

1. Bearing arrangement for a shaft in a sleeve which concentrically surrounds said shaft, at least one first rolling bearing with cylindrical rolling bodies which roll on an outer raceway of the shaft and an inner raceway of the sleeve, and a second rolling bearing with spherical rolling bodies which roll in a first running groove in the shaft and a second running groove in the sleeve, wherein the second rolling bearing is formed together with the shaft and the sleeve as a four-point bearing.

2. Bearing arrangement of a shaft in a sleeve which concentrically surrounds said shaft comprising: at least one first rolling bearing with cylindrical rolling bodies which roll on an outer raceway of the shaft and an inner raceway of the sleeve, and a second rolling bearing with spherical rolling bodies which roll in a first running groove in the shaft and a second running groove in the sleeve, wherein the second rolling bearing is formed together with the shaft and the sleeve as a three-point bearing.

3. Bearing arrangement according to claim 1, wherein two first rolling bearings are in each case embodied as single-row cylindrical roller bearings which are arranged at both sides of the second rolling bearing which is embodied as a four-point bearing.

4. Bearing arrangement according to claim 2, wherein the first rolling bearing is embodied as a single-row cylindrical roller bearing, with the second rolling bearing, which is embodied as a four-point bearing, being arranged with a spacing to the first rolling bearing.

5. Bearing arrangement according to claim 1, wherein the four-point bearing is formed with a nominal pressure angle α₀, where 25°≦α₀≦35°.

6. Bearing arrangement according to claim 1, wherein the second rolling bearing, which is embodied as a four-point bearing, is formed with a nominal pressure angle α₀=25°.

7. Bearing arrangement according to claim 2, wherein the spherical rolling bodies bear in the running groove with a nominal pressure angle α₀=25°.

8. Bearing arrangement according to claim 1, wherein a cylindrical roller bearing is combined with a three-point or four-point bearing which is arranged adjacent thereto.
